(19) United States
(12) Patent Application Publication
(10) Pub. No.: US 2001/0021659 A1
(43) Pub. Date: Sep. 13, 2001

(54) Method and system for connecting a mobile communication unit to a personal computer

(75) Inventor: Tatsuaki Okamura, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/802,187

(22) Filed: Mar. 8, 2001

(30) Foreign Application Priority Data
Mar. 8, 2000 (JP) 2000-063068

(51) Int. Cl. H04B 1/38

(52) U.S. Cl. 455/557; 455/550; 455/572; 455/127

(57) ABSTRACT

A mobile communication unit is connected to a computer by a connector. The connector has a recess for holding the mobile unit in position and a number of connector ports. Switching circuitry is provided for selectively establishing a logical connection between the internal circuitry of the computer and the internal circuitry of the mobile unit through the connector ports. The DC power source of the computer is used to charge the rechargeable battery of the mobile unit. The mobile communication unit is controlled according to a command signal entered to the computer.

### BACKGROUND OF THE INVENTION

1. Field of the Invention

The present invention relates generally to personal computers, and more specifically to a method and a system for connecting a mobile unit to a computer.

2. Description of the Related Prior Art

It is known to use a connection device for coupling a cellular mobile telephone to a personal computer to provide data communication via a mobile network. A known connection device as disclosed in Japanese Patent Publication 97-162960 is comprised of an AC-DC converter battery charger for charging the battery of the mobile unit with energy obtained from a commercial AC outlet. However, due to the use of AC-DC converter battery charger, a commercial AC outlet must be available at a suitable location and a power supply code must be attached to the connection device for receiving AC energy from the power outlet. Another connection device disclosed in Japanese Patent Publication 98-285254 includes a first power connector for exclusively for use in charging the battery of a mobile unit and a second power connector exclusively for use in operating the mobile unit. These power connectors are provided separately from a data connector that is used to transport data between the mobile unit and a personal computer. While the use of two power connectors allows the mobile unit to proceed communication with the mobile network while its battery is being charged, a power supply code is still required to receive energy from an external power source.

### SUMMARY OF THE INVENTION

It is therefore an object of the present invention to relieve the user of a computer and a mobile communication unit from the need to find a commercial AC output or a separate external power source and the need to use a power supply code for feeding the mobile unit.

According to a first aspect of the present invention, there is provided a method of connecting a mobile communication unit to a computer, comprising the steps of establishing a plurality of connections between internal circuitry of the mobile communication unit having a rechargeable battery and internal circuitry of a computer through a plurality of connector ports, supplying power from a power source of the computer to the rechargeable battery of the mobile communication unit, and controlling the mobile communication unit through one of the connections according to a command signal supplied to the computer.

According to a second aspect, the present invention provides a system for connecting a mobile communication unit to a computer. The system comprises connector having a recess for holding the mobile communication unit and a plurality of connector ports, switching circuitry for selectively establishing a connection between the internal circuitry of the computer and the internal circuitry of the mobile communication unit through the connector ports, power supply circuitry for supplying power from a power source of the computer to a rechargeable battery of the mobile communication unit, and control circuitry for controlling the mobile communication unit through the established connection according to a command signal entered to the computer.

According to a third aspect, the present invention provides a connection device for establishing connections between a computer and a mobile communication unit having a rechargeable battery. The connection device comprises a connector having a recess for holding the mobile communication unit and a plurality of connector ports, and an interface card connected through the connector ports to the internal circuitry of the mobile communication unit and connected through a serial port to the internal circuitry of the computer. The interface card includes power supply circuitry for supplying power from a power source of the computer to the rechargeable battery of the mobile communication unit, switching circuitry for selectively establishing a connection between the internal circuitry of the computer and the internal circuitry of the mobile communication unit through the connector ports, and control circuitry for controlling the mobile communication unit through the connection according to a command signal entered to the computer.

### BRIEF DESCRIPTION OF THE DRAWIGNS

The present invention will be described in detail further with reference to the following drawings, in which:

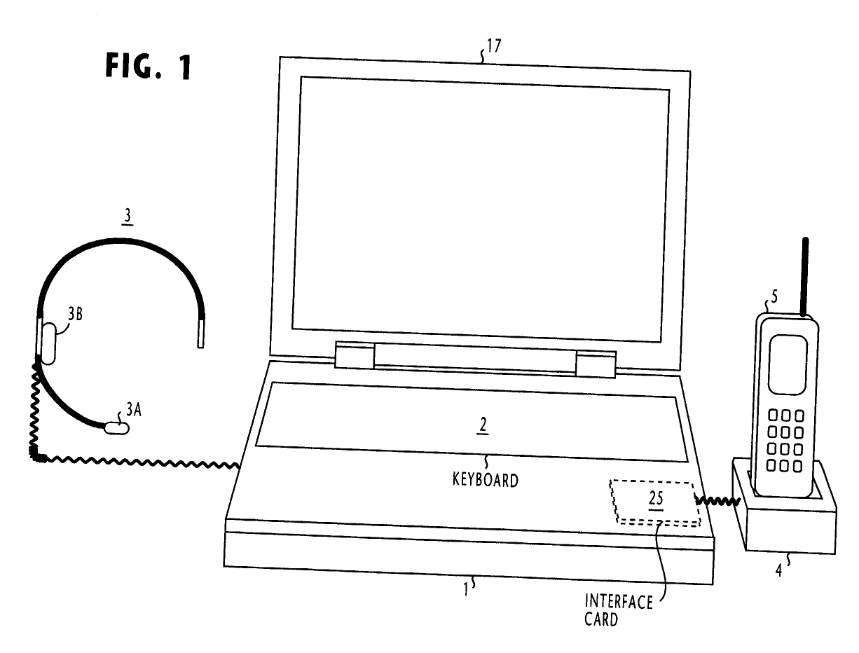

FIG. 1 is a perspective view of a notebook computer and a connector for coupling a mobile unit to the computer according to the present invention;

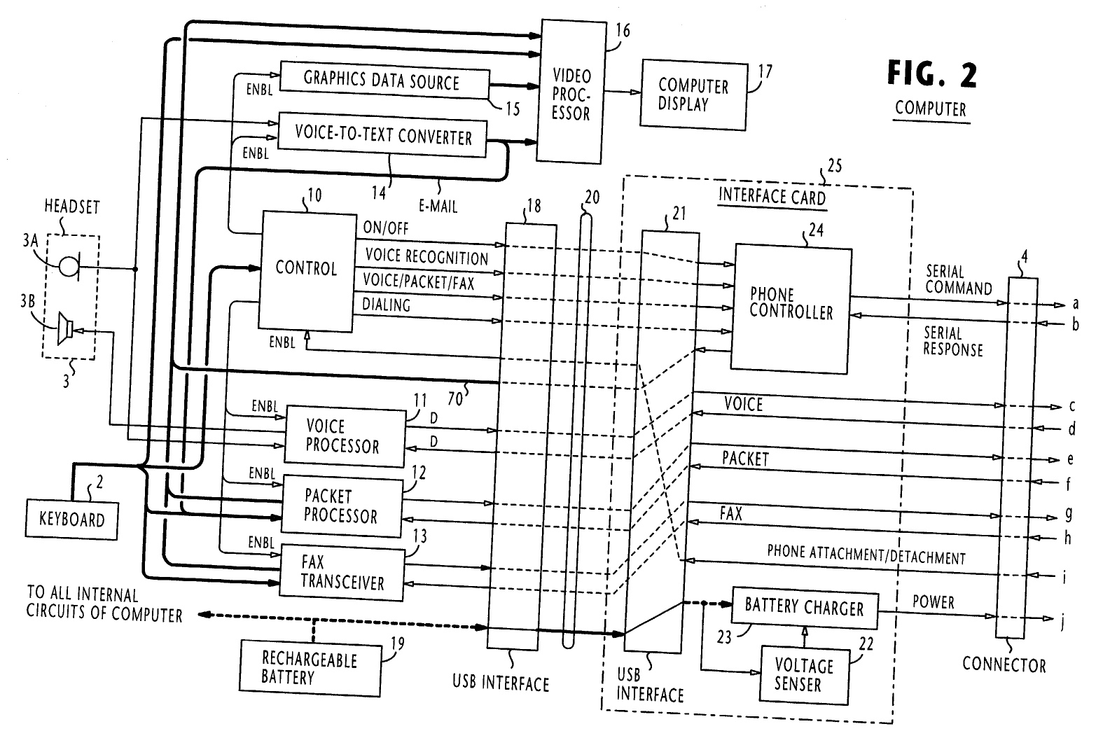

FIG. 2 is a block diagram of a personal computer and an interface card according to the present invention;

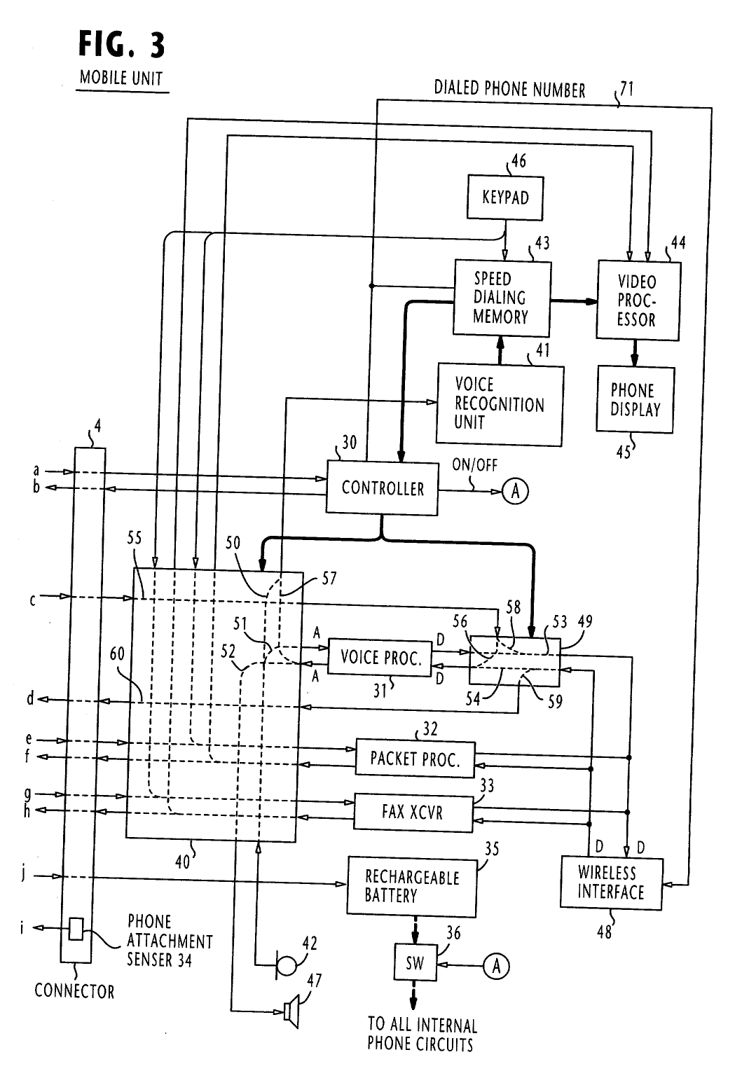

FIG. 3 is a block diagram of a mobile unit according to the present invention;

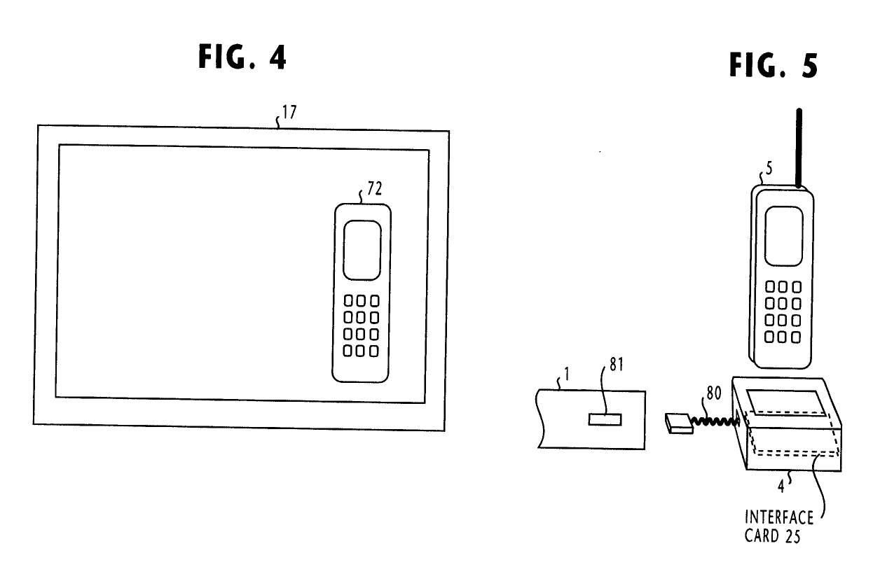

FIG. 4 is a perspective view of a computer screen on which a simulated image of the mobile unit is displayed; and

FIG. 5 is a perspective view of a connector in which the interface card of the present invention is installed.

### DETAILED DESCRIPTION

Referring to FIG. 1, there is shown a personal computer and a connector 4 for coupling a mobile communication unit 5 to the computer 1 and for operating the mobile unit 5 from the computer 1 according to the present invention. For the purpose of disclosure, the computer 1 is shown and described as a notebook computer having a keyboard 2 incorporated as an integral part of the computer. A headset 3 is connected to the computer 1 to be used by the computer user. The connector 4 has a recess in which the mobile unit 5 is placed in an upright position. Connector 4 establishes connections between its internal circuitry and an interface card 25 inserted in a slot formed in the housing of computer 1.

In FIG. 2, the notebook computer 1 includes a control circuit 10 to which the keyboard 2 of the computer 1 is connected, a voice processor 11, a packet processor 12 and a fax transceiver 13, all of which are connected to a USB (universal serial bus) interface 18. Voice processor 11 has a first analog input port for receiving a voice signal from the microphone 3A and converts it to a digital voice signal at a rate much lower than 64 kbps and a first digital output port from which the digital voice signal is delivered. In addition, the voice processor 11 has a second digital input port for receiving a lower-than-64 kbps digital voice signal from the mobile unit 5 and converts it to an analog voice signal and a second analog output port from which the analog voice signal is delivered to the speaker 3B.

In response to command signals from the keyboard 2, the controller 10 produces a number of control signals including an on/off control signal for providing a power-on-off control over the mobile unit 5, a voice recognition control signal for controlling the voice recognition circuit of the mobile unit, a mode control signal for operating the mobile unit in one of voice, packet and facsimile modes, and a dialing signal for placing a call in a manner as will be described. Further provided is a voice-to-text converter 14 connected to the microphone 3A for converting the voice input into character data, which is displayed via a video processor 16 on the screen of a display unit 17. A voice-input message for an electronic mail can be produced in this way and transmitted in packets from the packet processor 12.

A graphics data source 15 is provided to respond to an input from the keyboard 2 to produce a simulated image of the mobile unit on the computer screen in order that the user is given an impression that he is directly operating the mobile's keypad from the keyboard 2. All internal circuits of the computer 1 are supplied with a DC voltage from a rechargeable battery 19, which also supplies its power to the mobile unit via the USB interface 18. Keyboard 2 supplies a command to the controller 10 for enabling the voice-to-text converter 14 and the graphics data source 15.

Interface card 25 is connected to the connector 4 via industry-standardized connector ports designated “a” through “i” and a grounded port not shown. Interface card 25 includes a USB interface 21 which is coupled through a USB port 20 to the USB interface 18 of the computer 1. Battery power is supplied through the two power lines of the four-wire USB port 20 and all signals between the USB interfaces 18 and 21 are carried on the two signal lines of the USB port 20. The dotted lines in FIG. 2 indicate logical connections which will be established between the two USB interfaces under control of the controller 10 and phone controller 24.

A voltage sensor 22 and a battery charger 23 are provided. Voltage sensor 22 monitors the USB power lines to detect the voltage level of the rechargeable battery 19 and activates the battery charger 23 for charging the rechargeable battery of the mobile unit 5 when the computer's rechargeable battery 19 is charged at a level higher than a specified voltage.

A phone controller 24, provided in the interface card 25, is connected between the USB interface 21 and the connector 4. Phone controller 24 receives an on-off control signal from the controller 10 for controlling the power switch of the mobile unit 5 and supplying serial command data to and receiving serial response data from the mobile unit 5. Electronic mail can be exchanged in serial data through the phone controller 24. The user can benefit from the large computer screen to prepare text messages for e-mail transmission and keep a record of transmitted e-mail messages in a hard disk of the computer.

The voice recognition control signal from the controller 10 is repeated by the phone controller 24 to the mobile unit 5 in order to receive a response signal (text data) indicating a phone number corresponding to an uttered subscriber name into the microphone 3A. A phone attachment/detachment signal is received from the connector 4, the signal being applied to the USB interface 21 for activating the controller 10 when the mobile unit 5 is held in upright position on the connector 4.

In FIG. 3, the mobile unit 5 includes a controller 30 for providing interactive communication with the phone controller 24 by exchanging serial command and serial response signals. A voice processor 31 similar to the voice processor 11 is provided. A packet processor 32 and a fax transceiver 33 are provided for communication with the packet processor 12 and fax transceiver 13. A phone attachment sensor 34 is provided in the connector 4 to supply a phone attachment signal through connector port “i” to the interface card 25 in order to activate the controller 10 when the mobile unit is placed on the connector 4. When the mobile unit is removed from the connector 4, a phone detachment signal will be sent to the computer 1.

The mobile unit 5 has a rechargeable battery 35 that is charged with the DC voltage supplied from the rechargeable battery 19 of the computer. All internal circuits of the mobile unit 5 except for power saving circuitry are energized by the battery 35 via a power switch 36 which is controlled by an ON/Off control signal from the controller 30.

Switches 40 and 49 are provided to selectively establish paths or logical connections under control of the controller 30, as indicated by the dotted lines.

A wireless interface 48 is connected to the voice processor 31, packet processor 32 and fax transceiver 33 as well as to the memory 43 to receive a dialed phone number. Wireless interface 48 establishes a wireless communication link to the mobile network and initiates a call according to the phone number supplied from the memory 43. During an exclusively mobile mode, the switch 40 connects the voice processor 31 to the microphone 42 and a speaker 47 and connects the packet processor 32 and fax transceiver 33 to the video processor 44 and the keypad 46.

Mobile unit 5 is provided with a voice recognition unit 41. When the mobile unit is not connected to the computer 1 and the voice recognition unit 41 can be used for addressing the speed dialing memory 43 for a phone number corresponding to an input voice. In this case, the controller 30 controls the switch 40 to establish a path 50 for coupling the microphone 42 to the voice recognition unit 41. The voice input from the microphone 42 is converted by the voice recognition unit 41 to text data, which is used by the memory 43 to make a search for a corresponding phone number, the phone number being displayed on the display panel 45 and used for initiating a call to the mobile network through a wireless interface 48. When a call is established, the controller 30 controls the switches 40 and 49 so that paths 51 and 52 are established between the microphone 42 and speaker 47 on the one hand and the analog input and output ports of the voice processor 31 on the other, and paths 53 and 54 are established between the digital output and input ports of the voice processor 31 and the wireless interface 48.

Speed dialing memory 43 is connected to a video processor 44, through which phone numbers read out of the memory 43 can be displayed on a phone display panel 45. When the mobile unit is not attached to the computer 1, the phone display 45 provides a display of a phone number supplied from the speed dialing memory 43 and textual data generated by a keypad 46.

The following is a description of the operation of the computer 1 when the mobile unit 5 is attached to the computer by way of the connector 4.

When the mobile unit 5 is held in position on the recess of connector 4, the phone attachment sensor 34 senses its presence and produces a phone attachment signal, which is sent through connector port “i” to the controller 10 via USB interfaces 21 and 18. Note that all signals communicated between the USB interfaces 18 and 21 over the USB port 20 are in the form of packets. Controller 10 is enabled in response to the phone attachment signal so that it is ready for accepting command signals from the keyboard 2.

In response to a keyboard operation by the user, the controller 10 produces a turn-on signal, which is sent through the phone controller 24 to the controller 30 of the mobile unit and turns on the switch 36. Mobile unit 5 is activated to establish a wireless control channel to the mobile network. As long as the voltage of rechargeable battery 19 is higher than a specified level, the voltage sensor 22 will activate the battery charger 23 for charging the mobile's rechargeable battery 35 through connector port “j”

If the user desires to place a phone call using the mobile's speed dialing memory 43 and voice recognition unit 41 in a manner similar to that during the exclusive mobile mode, he sets the controller 10 through the keyboard 2 to produce a voice recognition control signal and a telephony (voice) mode signal, which are applied to the phone controller 24. Controller 24 repeats the signals to the controller 30 via connector port “a”. Controller 30 operates the switches 40 and 49 to establish paths 55 and 56 for connecting the digital output of voice processor 11 which is applied through connector port “c” to the digital input of voice processor 31 and a path 57 (in switch 40) for connecting the analog output of the voice processor 31 to the voice recognition unit 41. Simultaneously, the voice processor 11 is enabled by the controller 10.

The user then utters the name of a called party into the microphone 3A. The voice signal from the microphone 3A is applied to the voice processor 11, where the voice input is converted to a low-rate digital speech signal and sent through connector port “c” to the voice processor 31. An analog voice output is generated by the voice processor 31 and applied through the path 57 to the voice recognition unit 41 and converted to text data, which is used by the memory 43 to make a search for a corresponding phone number. This phone number is sent from the controller 30 through connector port “b” to the phone controller 24, where it is delivered through a control bus 70 to the video processor 16 and displayed on the screen of the computer display 17. On the other hand, the same phone number is supplied on line 71 (FIG. 3) to the wireless interface 48 for initiating a call. When a call is established, the controller 30 controls the switches 40 and 49 so that paths 58, 59 and 60 are established for connecting the digital output of voice processor 11 (which is received through connector port “c”) to the digital input of the wireless interface 48 and connecting the digital output of wireless interface 48 to the digital input of voice processor 11 via connector port “d”.

When the user activates the graphics data source 15 through keyboard 2, an image 72 of the mobile unit 5 is displayed on the computer screen as shown in FIG. 4.

By operating a numeral key on the keyboard 2, the corresponding key is lit on the simulated mobile's image. At the same time, the entered numeral data is sent from the controller 10 to the phone controller 24 which repeats the signal to the mobile controller 30. By repeating this process, the user can enter the address information of a called party and the controller 30 receives this address information and sends it to the wireless interface 48 through line 71, which then establishes a communication link through the cellular mobile network.

When the user enables the voice-to-text converter 14 through the keyboard 2, a voice message can be entered through the microphone 3A to the voice-to-text converter 14, from which a text-converted data is supplied to the video processor 16 and displayed on the computer screen. An electronic mail can be formulated with such text data and transmitted to the mobile's controller 30 through USB interfaces 18, 21 and phone controller 24 to the connector port “a”. In this way, the user is relieved of having to manipulate the mobile's small keys which are usually need to be operated repeatedly for entering a desired character.

Phone controller 24 allows phone numbers entered through the keyboard 2 to be transmitted as serial data through connector port “a”and stored into the speed dialing memory 43 of the mobile unit and allows e-mail messages to be displayed on the computer screen, instead of on the small-sized mobile's screen. Further, the phone controller 24 allows all operating status information of the mobile unit 5 to be received through serial data port “b” and put on display on the computer screen.

The user can specify from the keyboard 2 to the controller 10 as to which one of packet and facsimile modes is used to initiate a call. In response to such a keyboard input, the controller 10 produces a mode select signal (packet/fax) and enables one of the packet processor 12 or fax transceiver 13, which is repeated by the phone controller 24 to the mobile's controller 30 via connector port “a”. Controller 30, in response, establishes a two-way path in the switch 40 between one of the packet processor 12 and fax transceiver 13 and a corresponding one of the packet processor 32 and fax transceiver 33.

If the call is in a telephony mode, the voice input to the microphone 3A is applied to the voice processor 11, where the signal is converted according to a predetermined coding algorithm to a lower-than-64-kbps digital voice signal and passed through the switches 40 and 49 to the wireless interface 48. This signal is translated to an uplink signal and transmitted to the mobile network. Digital voice signal from the network is carried on a downlink signal and received by the wireless interface 48, the digital voice signal being supplied via the switches 49 and 40 and connector ports “c” and “d” to the voice processor 11 where it is processed back to the original analog signal and applied to the speaker 3B.

If the mode select signal from the controller 10 indicates that the user wishes to send packets, the packet processor 12 is enabled by the controller 10 to send packets to the mobile's packet processor 32 via connector port “e” for transmission to the mobile network. Packets from the network are first processed by the mobile's packet processor 32 and sent to the computer's packet processor 12 to be displayed on the computer screen. In a similar manner, the fax transceivers 13 and 33 are used for exchanging fax signals with remote stations.

It is seen that the user is relieved from the need to find a commercial AC outlet for charging the mobile unit 5 and from the need to use a power code for coupling the mobile unit to the AC outlet. Another advantage of the present invention is that since the AC power supply is not necessary the mobile unit 5 no longer needs an AC-DC converter battery charger which adds an extra weight to the mobile unit.

With the combined use of a personal computer and a mobile unit, the user can access a wide range of multimedia applications on a simultaneous basis by utilizing the large screen size of the computer and the communication functions of the mobile unit such as video, voice and fax services.

FIG. 5 shows an alternative embodiment of the present invention. In this embodiment, the interface card 25 is located within the housing of the connector 4. In this case, the USB port 20 takes the form of a four-wire cable 80 extending from the connector 4 to a USB port 81 of the computer 1.

What is claimed is:

1. A method of connecting a mobile communication unit to a computer, comprising the steps of:
a) establishing a plurality of connections between internal circuitry of said mobile communication unit having a rechargeable battery and internal circuitry of a computer through a plurality of connector ports;
b) supplying power from a power source of said computer to said rechargeable battery of the mobile communication unit; and
c) controlling said mobile communication unit through one of said connections according to a command signal supplied to said computer.

2. The connecting method of claim 1, wherein step (c) comprises detecting a voltage generated by said power source of the computer and supplying power to said mobile communication unit when the detected voltage is higher than a specified voltage level.

3. The connecting method of claim 1, wherein step (c) comprises the step of providing power on-off control on said mobile communication unit according a command signal entered to said computer.

4. The connecting method of claim 1, wherein said mobile communication unit comprises a voice recognition circuit and a memory for storing a plurality of stored phone numbers and reading one of the stored phone numbers corresponding to an output signal of the voice recognition circuit, and wherein step (c) comprises supplying a voice signal from a microphone to said voice recognition circuit, receiving a phone number read from said memory in response to an output signal of the voice recognition circuit which is produced as a result of said voice signal, and displaying the received phone number on a screen of said computer.

5. The connecting method of claim 1, further comprising displaying a simulated image of said mobile communication unit on a screen of said computer.

6. The connecting method of claim 1, wherein said computer is provided with a voice input/output device, and wherein step (c) comprises controlling said mobile communication unit to establish a wireless link between said voice input/output device and a mobile communication network.

7. The connecting method of claim 1, wherein said computer is provided with a packet processor, and wherein step (c) comprises controlling said mobile communication unit to establish a wireless link between said packet processor and a mobile communication network.

8. The connecting method of claim 1, wherein said computer is provided with a facsimile transceiver, and wherein step (c) comprises controlling said mobile communication unit to establish a wireless link between said facsimile transceiver and a mobile communication network.

9. A system for connecting a mobile communication unit from a computer, comprising:
a connector having a recess for holding the mobile communication unit and a plurality of connector ports;
switching circuitry for selectively establishing a connection between the internal circuitry of the computer and the internal circuitry of said mobile communication unit through said connector ports;
power supply circuitry for supplying power from a power source of said computer to a rechargeable battery of said mobile communication unit; and
control circuitry for controlling said mobile communication unit through said connection according to a command signal entered to said computer.

10. The connecting system of claim 9, wherein said control circuitry is provided in an interface card which is located within a slot of said computer.

11. The connecting system of claim 9, wherein said control circuitry is provided in an interface card which is located within said connector.

12. The connecting system of claim 9, wherein said serial port is in accordance with specifications of Universal Serial Bus port.

13. The connecting system of claim 9, wherein said control circuitry is responsive to a command signal for providing a power on-off control on said mobile communication unit.

14. The connecting system of claim 9, further comprising a voltage sensor for detecting a voltage generated by said power source of the computer and a battery charger for supplying said power to said mobile communication unit when the detected voltage is higher than a specified voltage level.

15. The connecting system of claim 9, wherein said mobile communication unit comprises:
a voice recognition circuit; and
a memory for storing a plurality of stored phone numbers and reading one of the stored phone numbers corresponding to an output signal of the voice recognition circuit,
wherein said control circuitry is configured to supply a voice signal from a microphone to said voice recognition circuit, receive a phone number read from said memory in response to an output signal of the voice recognition circuit which is produced as a result of said voice signal, and display the received phone number on a screen of said computer.

16. The connecting system of claim 9, further comprising a graphics data source for displaying a simulated image of said mobile communication unit on a screen of said computer.

17. The connecting system of claim 9, wherein said computer is provided with a voice input/output device, and wherein said control circuitry is configured to control said mobile communication unit to establish a wireless link between said voice input/output device and a mobile communication network.

18. The connecting system of claim 9, wherein said computer is provided with a packet processor, and wherein said control circuitry is configured to control said mobile communication unit to establish a wireless link between said packet processor and a mobile communication network.

19. The connecting system of claim 9, wherein said computer is provided with a facsimile transceiver, and wherein said control circuitry is configured to control said mobile communication unit to establish a wireless link between said facsimile transceiver and a mobile communication network.

20. A connection device for establishing connections between a computer and a mobile communication unit having a rechargeable battery, comprising:
a connector having a recess for holding the mobile communication unit and a plurality of connector ports; and
an interface card connected through said connector ports to the internal circuitry of said mobile communication unit and connected through a serial port to said internal circuitry of said computer,
said interface card including:
power supply circuitry for supplying power from a power source of said computer to said rechargeable battery of the mobile communication unit;
switching circuitry for selectively establishing a connection between the internal circuitry of the computer and the internal circuitry of the mobile communication unit through said connector ports; and
control circuitry for controlling said mobile communication unit through said connection according to a command signal entered to said computer.

21. The connection device of claim 20, wherein said interface card is located within a slot of said computer.

22. The connection device of claim 20, wherein said interface card is located within said connector.

23. The connection device of claim 20, wherein said interface card is connected to said computer via a Universal Serial Bus port.
